(19) United States
(12) Patent Application Publication
(10) Pub. No.: US 2022/0255466 A1
(43) Pub. Date: Aug. 11, 2022

(54) METHOD AND APPARATUS FOR GENERATING ENERGY FROM FLUID FLOW

(71) Applicant: STUART MACKENZIE, CALGARY (CA)

(72) Inventor: STUART MACKENZIE, CALGARY (CA)

(21) Appl. No.: 17/173,283

(22) Filed: Feb. 11, 2021

(51) Int. Cl. H02N 1/08

(52) U.S. Cl. CPC H02N 1/08

(57) ABSTRACT

This disclosure describes various embodiments of energy converters, such as electrical generators, that effectively use oscillations induced by flowing fluids in generating electricity by converting energy present in fluid flows, such as airflows. In one aspect, an exemplary generator converts the kinetic energy of an airflow into oscillations of a flexible film and supporting flow control structure. The film and supporting structure are surfaced with a pattern of electrical conductors that allow the system to operate as an electrostatic induction generator.

### FIELD OF THE INVENTION

This application generally relates to techniques of harvesting energy from flowing fluids, such as air, and more specifically, to designs and structures of energy converters that convert kinetic energy embedded in the flowing fluids to other types of energy, such as electricity, by promoting and utilizing oscillations induced by flowing fluids.

### BACKGROUND OF THE INVENTION

This disclosure describes various embodiments of novel energy converters, such as electrical generators, that effectively promote oscillations induced by flowing fluids, and utilize the oscillations in generating electricity by converting energy present in fluid flows, such as airflows. In one aspect, an exemplary generator converts the kinetic energy of an airflow into oscillations of a flexible film and supporting flow control structure. The film and supporting structure are surfaced with a pattern of electrical conductors that allow the system to operate as an electrostatic induction generator. The apparatus must be supported on at least one end, and has at least three electrically conductive areas known in the prior art as “sectors”. The sectors are configured so that they can use their electric fields to drive current to and from other sectors, accumulate charge, and supply current to power harvesting circuits.

Much of the prior art relating to electrostatic induction generators was developed in the late 1800's. Electrostatic induction generators or “influence machines” were the precursor to electromagnetic induction generators, with a number of designs based on rotating glass discs carrying conductive metallic sectors. These generators were used to power some of the earliest medical X-ray machines, but were otherwise limited in practical use, partly due to the very high voltage and low current output. The machines were commonly designed to operate at voltages in excess of 250,000 volts.

In the contemporary prior art, there are a number of references including U.S. Pat. Nos. 6,153,944; 6,936,994; 7,439,630; 8,633,608; 10,270,369; 10,333,430; and US Patent Publication No. 20110084493.

Frayne, in United States Publication No. 20080297119, provides an energy converter for inducing membrane vibrations of a membrane when subjected to a fluid flow. The vibrations are converted electricity. A magnetic field generator is configured to apply a magnetic field to an electrical conductor. In fluid flow, the membrane vibrates and creates a relative movement between the conductor and the magnetic field to induce a current.

“TENG” or “triboelectric nanogenerator” is a further variation on devices used to generate electrostatic energy. This technology employs thin plastics and outputs high voltage, low current electricity. These arrangements work on the rubbing of dissimilar materials allowing the electricity to arc to a nearby electrode.

Conveniently the technology herein has a number of advantages over conventional generators, including:
i) It can be constructed at a very low cost, from recyclable materials;
ii) It has a noise profile similar to that produced by a flag flapping in the wind;
iii) The mass of apparatus is low compared to electromagnetic based wind generators, which makes it amenable to installation in a variety of locations without extensive supporting structures;
iv) The low mass of the generator also makes it suitable for integration into airborne wind generators;
v) It may be designed to operate efficiently in small sizes;
vi) It may be designed to operate at low wind speeds;
vii) It may be designed to be resilient at high wind speeds; and
viii) It may be combined with other thin film power generating materials, such as photovoltaic and piezoelectric thin films.

### SUMMARY OF THE INVENTION

One object of one embodiment of the present invention is to provide an improved arrangement and method for generating and collecting electric potential energy from the kinetic energy inherent with a flowing fluid.

A further object of one embodiment of the present invention is to provide an apparatus for generating energy from a flowing fluid, comprising:

a flexible member including electrically conductive material;

a retaining member for receiving the conductive flexible member, the retaining member having an open structure to facilitate fluid flow therethrough to oscillate the flexible member within the retaining member; and electrically conductive material associated with the retaining member operable with the conductive material of the flexible member to generate electricity when the flexible member is oscillated within the retaining member by fluid flow.

The film may be printed with conductive ink, metalized, or otherwise surfaced with a pattern of conductive material to form electrical circuits and components. When using capacitive elements, the capacitive elements are generally referenced as sectors.

The film and retaining structure are surfaced with a pattern of conductive material causing the apparatus to operate as an electrostatic power generator. The conductive material operates as the variable electric field component of an electrostatic power generator and may be applied in a predetermined pattern, depending on the shape, size, etc., of the film.

To prevent the buildup of static charges on the film and containing structure, and to prevent the loss of electrical charges to the surrounding air, the conductive surfaces may be covered with a layer of electrical insulation.

The electrical surfaces may be periodically reversed in operating polarity in order to prevent the buildup of static charges on the film and retaining member. In one embodiment, the retaining member may comprise flexible film equipped with diodes, transistors, or switches attached to or integrated into the surface.

In other embodiments, multiple arrangements of the film and retaining member are arranged in an array.

The apparatus may be supported by or integrated with a supporting structure, examples of which include a flagpole, lighting standard, a kite, balloon, a windsock, a boat mast or rigging, vehicle, building, weathervane, etc. Other suitable examples will be appreciated by those skilled in the art.

The apparatus can be electrically connected to a power conditioning or harvesting circuit, examples of which are well known in the prior art. Optionally, the film or retaining member may include suitable components to harvest the collected energy. Suitable arrangements of, for example, capacitors may be utilized.

A further object of one embodiment of the present invention is to provide a method of generating electrical energy from a flowing fluid, comprising:

providing a flexible conductive member positioned for oscillation within a conductive retaining member;

exposing at least one of the flexible conductive member and supporting structure to fluid flow;

oscillating the relative position of flexible conductive member within the conductive retaining member to generate electric potential energy; and

collecting generated electric potential energy.

The conductive retaining member limits the degree of oscillation of the flexible conductive member disposed therein, while at the same time functioning to generate the electric potential.

A plurality of conductors on the major faces of the flexible conductive member facilitates electrostatic induction when the position of the flexible conductive member changes, by oscillation, relative to the conductive retaining member. The plurality of conductors may be positioned in a predetermined pattern on the major faces.

The flexible conductive member within the conductive retaining member has a free trailing edge and a fixed or partially fixed leading edge. The free trailing edge during oscillation of the flexible member can experience localized vortices which can contribute to the oscillation efficiency.

The flexible conductive member within the conductive retaining member and supporting structure can be sized and supported with appropriate geometry and flexibility to efficiently extract energy from the vortices shed by an upwind object, such as a pole or building.

The conductive retaining member may include a plurality of apertures in a predetermined pattern to facilitate oscillations resulting in maximum electric field variation between the conductive retaining member and the flexible conductive member.

### BRIEF DESCRIPTION OF THE DRAWINGS

FIGS. 1 through 1C are schematic illustrations of the oscillation sequence within the retaining member illustrating the oscillation of the conductive flexible film;

FIG. 2 is a schematic illustration of an alternate embodiment of the retaining member;

FIG. 3 is a schematic illustration of another alternate embodiment of the retaining member;

FIG. 4 is a schematic illustration of a still further alternate embodiment of the retaining member;

FIG. 5 is a schematic illustration of an electric potential generator formed with a plurality of retaining members and flexible films;

FIG. 6 is an exploded view of the apparatus illustrating the respective sectors attributed to the retaining member and conductive film;

FIG. 6A is an exploded view of an alternate embodiment of FIG. 6;

FIG. 7 is a schematic illustration of the apparatus connected with a support structure; and

FIG. 8 is a schematic illustration showing the variation in support structure alternatives.

Similar numerals used in the drawings denote similar elements.

### DETAILED DESCRIPTION OF THE PREFERRED EMBODIMENTS

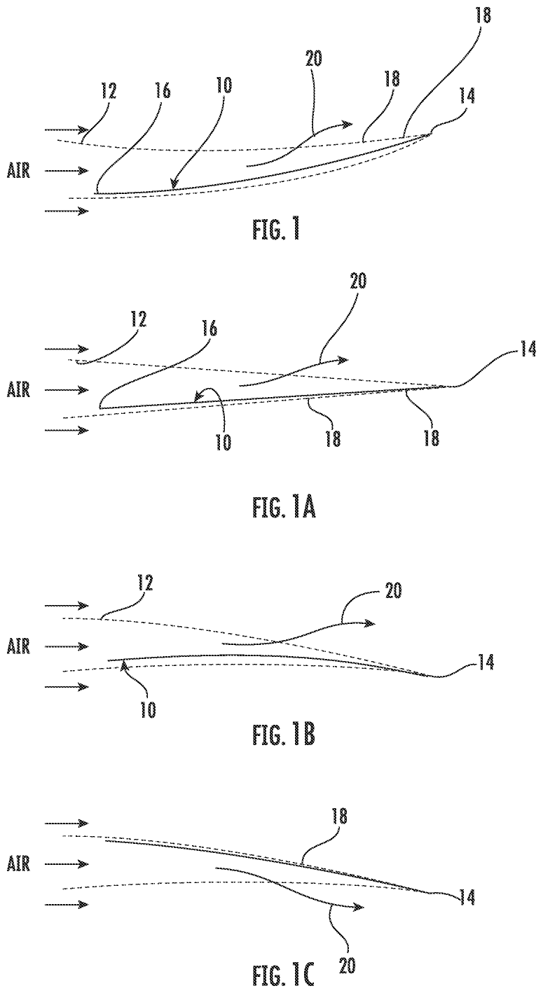

Referring initially to FIGS. 1 through 1C, shown is a series of schematic illustrations of the general parts and operation of the apparatus.

A flexible film 10 having electronic components integrated therewith (not shown—discussed herein after) is positioned within a retaining member 12, also having integrated electronic components therewith (not shown—discussed herein after). Film 10 is fixedly secured at one end 14 (leading edge) within the retaining member 12 and has a free trailing edge 16 spaced from end 14.

The retaining member 12 includes electronic components (not shown—discussed herein after) that cooperate with the electronic components, supra, of film 10 to generate electric potential energy. In the example, the retaining member 12 comprises a flexible material. The retaining member 12 includes apertures 18 to allow fluid flow, such as the wind to transmit force to the flexible film 10 and allow the latter to oscillate from one side of the retaining member 12 to the other side as shown in the Figure. The airflow pattern is denoted with numeral 20.

The number and arrangement of apertures 20 will vary depending on the overall size of the structure of the retaining member 12 and film 10, and desired operating windspeeds of the airflow to which the structure is exposed inter alia. The retaining member 12 limits and controls the degree of oscillation of the flexible film 10 and is generally in the form of a channel which also serves to concentrate air flow to the flexible film 10 as illustrated in the example.

Turning now to FIG. 2, shown is an alternate embodiment where the apertures 18 in the retaining member 12 are sized differently and positioned in a predetermined pattern.

FIG. 3 depicts a further alternate embodiment where the retaining member 12 comprises an open structure with discrete fingers referenced with numeral 22. Where the retaining member comprises a flexible film, interconnecting segments 24 may be utilized to facilitate controlled retention and oscillation of film 10 disposed between retaining member 12.

In the alternative where the fingers 22 are composed of a rigid or semi rigid material, the interconnecting segments 24 will not be necessary.

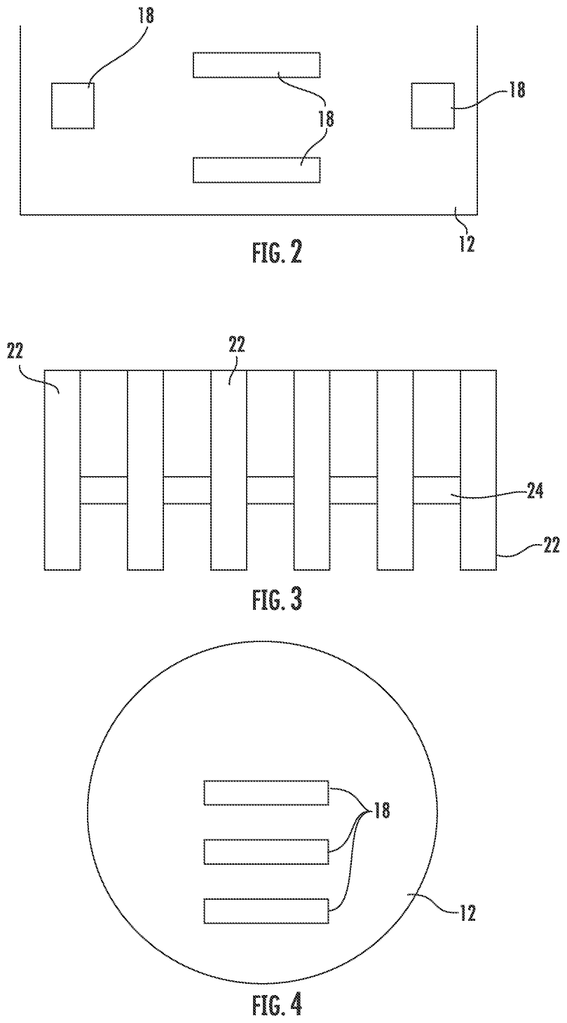

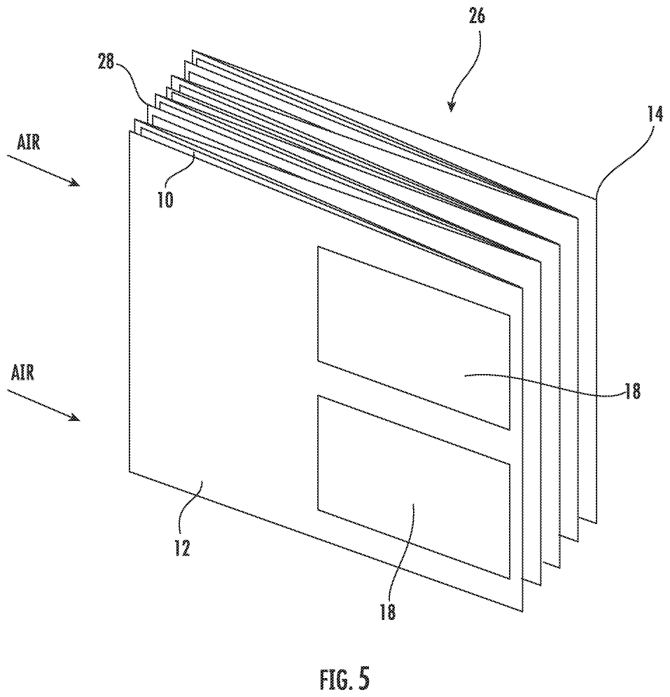

FIG. 4 illustrates a further variant, where the retaining member 12 is generally circular in shape. Other suitable shapes will be appreciated by those skilled in the art.

FIG. 5 is yet another variant of the invention where a plurality of retaining members 12 and film 10 are connected to form an electric potential energy collector 26 having a plurality of flexible film members 10 and conductive retaining members 12 in a predetermined quantity to harvest kinetic energy from a flowing fluid through oscillation of the conductive film members 10. In this embodiment, adjacent members 12 are commonly connected at 28 forming an accordion type structure.

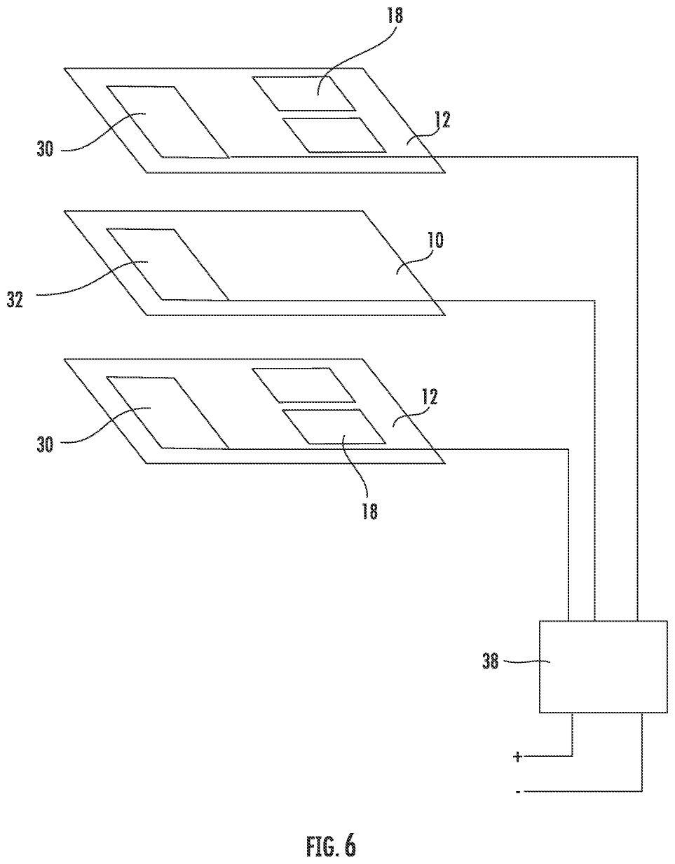

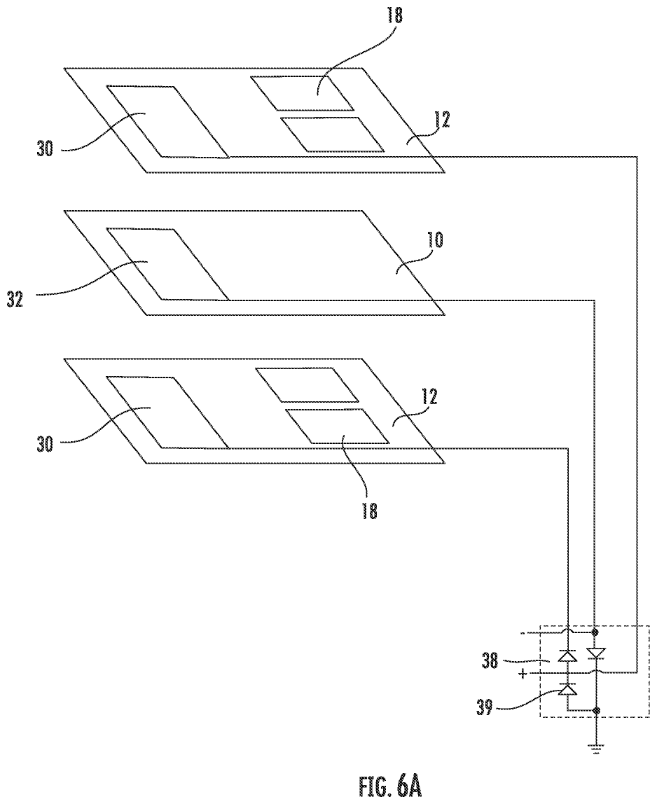

FIG. 6 is an exploded view of the overall structure where the retaining member 12 has its top and bottom layers separated to illustrate the conductive sectors 30 layered on or into the retaining member section.

Similar to the retaining member 12, the flexible film 10 also includes sectors 32 for electrostatic interaction with the retaining member sectors 30, when the arrangement is exposed to airflow. The sectors 30 and 32 are insulated (not shown) to prevent direct contact.

The sectors 30 and 32 are configured in a predetermined pattern to enable a maximum amount of oscillation based electric field variance thus facilitating the transfer of electric charges to a harvesting circuit or charge storage device 38. The harvesting circuit 38 will allow the accumulation of charges on the sectors 30, 32 to increase the electric field strength and thus increase the energy harvested. Positive and negative conductors 34 and 36, respectively can transmit the charges to the harvesting circuit or storage device 38, an example of which may be a capacitor, battery, etc.

As an alternative, FIG. 6A illustrates portions of the harvesting circuit 38 including electrical contact surfaces functioning as switches on the surface of retaining member 12, and flexible film 10. In the example, the switches are depicted as a diode network 39.

One possible example suitable for use in the apparatus for a harvesting circuit 38, is taught by Antonio Carlos M. de Queiroz, in the article, Simulation of MEMS Energy Harvesting Generators Based on Bennet's Doubler, COPPE/EP—Electrical Engineering Program Federal University of Rio de Janeiro, Rio de Janeiro, Brazil, IEEE, 2015. Numerous other suitable examples will be appreciated by those skilled in the art.

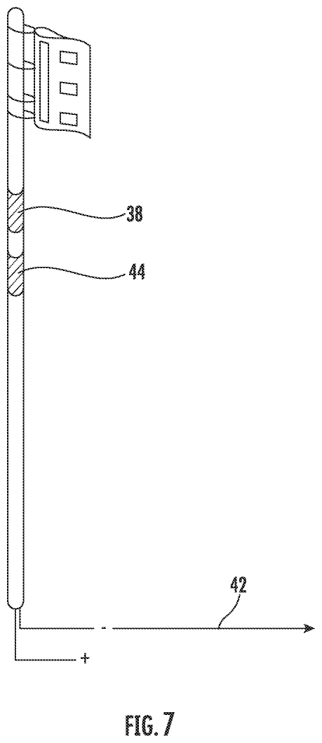

FIG. 7 is a schematic illustration of an alternate embodiment where the apparatus is supported on a support structure 40, shown in the example as a rod 40. In this manner, the apparatus can operate similar to a flag on a flagpole where the oscillation of the film 10 (not shown) can oscillate within the retaining member with the induced electric potential generated from the sectors 30 and 32 being harvested using external harvesting circuit 38, and either collected by the accumulators 34 and 36 utilized for other purposes denoted by numeral 42, stored in a storage device 44 in or on the support 40.

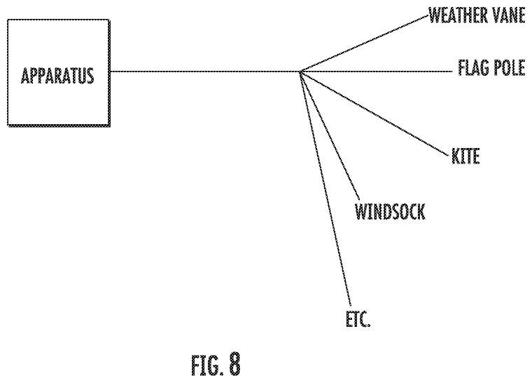

FIG. 8 is a schematic illustration of other support structures that could be linked or amalgamated with the apparatus. As examples, the support structure 40 may be a weathervane, a flagpole, balloon, lighting standard, a kite, a windsock, a boat mast or rigging, vehicle, building inter alia.

Advantageously, the apparatus operates at a variety of wind speeds, including lower speeds than required for most turbine-based generators. Moreover, the cost of the apparatus discussed herein is substantially lower than most other fluid flow harvesting generators. The absence of physically grinding parts offers the possibility of long, quiet, maintenance-free operation.

I claim:

1. Apparatus for generating energy from a flowing fluid, comprising:
a flexible member including electrically conductive material;
a retaining member for receiving said conductive flexible member, said retaining member having an open structure to facilitate fluid flow therethrough to oscillate said flexible member within said retaining member; and
electrically conductive material associated with said retaining member operable with said conductive material of said flexible member to generate electricity when said flexible member is oscillated within said retaining member by fluid flow.

2. The apparatus as set forth in claim 1, wherein said retaining member comprises a channel having spaced apart sides for contacting a respective side of said flexible member during oscillation by fluid flow.

3. The apparatus as set forth in claim 1, wherein said retaining member comprises flexible film.

4. The apparatus as set forth in claim 1, wherein said retaining member comprises spaced apart fingers for limiting the amount of oscillation there between of said flexible member.

5. The apparatus as set forth in claim 1, wherein said apparatus includes electrical insulation in predetermined areas of at least one of said flexible member and said retaining member.

6. The apparatus as set forth in claim 1, wherein said apparatus includes a collection circuit for collecting electrical energy generated during oscillation.

7. The apparatus as set forth in claim 1, in combination with a supporting structure.

8. The apparatus as set forth in claim 7, wherein said supporting structure comprises a member selected from the group comprising a weathervane, a flagpole, lighting standard, a kite, a balloon, a windsock, a boat mast or rigging, vehicle.

9. The apparatus as set forth in claim 1, wherein a plurality of said apparatus are connected in a predetermined arrangement for increased electrical energy generation.

10. A method of generating electrical energy from a flowing fluid, comprising:
providing a flexible conductive member positioned for oscillation within a conductive retaining member;
exposing at least one of the flexible conductive member and supporting structure to fluid flow;
oscillating the relative position of flexible conductive member within the conductive retaining member to generate electric potential energy; and
collecting generated electric potential energy.

11. The method as set forth in claim 10, wherein said conductive retaining member limits the degree of oscillation of said flexible conductive member disposed therein.

12. The method as set forth in claim 10, further including the step of providing a plurality of conductors on the major faces of said flexible conductive member to generate electrostatic induction when said flexible conductive member contacts, by oscillation, said conductive retaining member.

13. The method as set forth in claim 10, further including the step of positioning said plurality of conductors in a predetermined pattern on said major faces.

14. The method as set forth in claim 10, further including the step of storing collected electric potential energy on said conductive retaining member.

15. The method as set forth in claim 10, further including the step of positioning said flexible conductive member within said conductive retaining member where said flexible conductive member has a free trailing edge and a fixed leading edge.

16. The method as set forth in claim 10, further including the step of providing a plurality of apertures in said conductive retaining member in a predetermined pattern to facilitate maximum electric field variation between said conductive retaining member and said flexible conductive member during oscillation.

17. The method as set forth in claim 10, further including the step of utilizing a rigid conductive retaining member.

18. The method as set forth in claim 10, further including the step of utilizing a flexible conductive retaining member.

19. The method as set forth in claim 10, further including the step of fixing said conductive retaining member to a supporting structure disposed in a fluid stream.

20. The method as set forth in claim 10, further including the step of forming an electric potential energy collector comprising a plurality of flexible conductive members and conductive retaining members in a predetermined quantity to harvest kinetic energy from a flowing fluid through oscillation of said flexible conductive members.
